(19) United States
(12) Patent Application Publication
(10) Pub. No.: US 2005/0265919 A1
(43) Pub. Date: Dec. 1, 2005

(54) Method and apparatus for cooling in hydrogen plants

(75) Inventors: Franklin D. Lomax JR., Arlington, VA (US); Khalil M. Nasser, Alexandria, VA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: H2GEN INNOVATIONS, INC., Alexandria, VA (US)

(21) Appl. No.: 10/855,347

(22) Filed: May 28, 2004

(51) Int. Cl. C01B 3/26; B01J 7/00

(52) U.S. Cl. 423/651; 48/127.9; 48/61

(57) ABSTRACT

A hydrogen plant including a fuel reforming plant configured to receive and process hydrocarbon feedstock and configured to discharge wet reformate including a hydrogen-containing gas stream, and a condenser configured to cool the wet reformate. The hydrogen plant also includes a water separator configured to receive the cooled wet reformate, remove water from the wet reformate, and discharge dry reformate. The hydrogen plant further includes a hydrogen purifier configured to receive the dry reformate, process the dry reformate, and discharge pure or substantially pure hydrogen. A supplemental cooling system is provided in the hydrogen plant to cool the wet reformate in addition to the condenser.

### BACKGROUND OF THE INVENTION

1. Field of the Invention

The present invention relates to method and apparatus for cooling reformate gas in a hydrogen plant.

2. Discussion of the Background

Hydrogen has been commercially produced from hydrocarbon feedstocks since the turn of the century. Modern hydrogen plants fueled by natural gas, liquefied petroleum gas (LPG) such as propane, or other hydrocarbons are an important source of hydrogen for ammonia synthesis, petroleum refining, and other industrial purposes. These hydrogen plants share a common family of processing steps, which is referred to as “reforming,” to convert the hydrocarbon feedstock to a hydrogen-containing gas stream, which is referred to as “reformate.” Reformate gas usually contains at least twenty-fine percent water vapor by volume when it leaves the reforming process plant.

Pure hydrogen or substantially pure hydrogen is manufactured from reformate gas. This hydrogen may have a purity as low as 99%, although specific applications often require purities which are higher, often with less than 5 parts per million of total impurities required. The manufacturing of pure or substantially pure hydrogen is generally accomplished through the use of pressure swing adsorption (PSA). The reformate gas should be substantially cooled from elevated temperatures prior to the purification step. This cooling causes the saturation pressure of water to decrease, and thus leads to the condensation of liquid water. This liquid water is subsequently removed from the reformate gas prior to purification. In typical systems, the reformate gas is conveyed to the hydrogen purification apparatus at or near saturated conditions at the temperature and pressure of the stream.

The adsorbents utilized in PSA systems are extremely sensitive to water vapor. Excessive water vapor can be very strongly adsorbed by the PSA adsorbents, effectively deactivating them. Thus, PSA systems are generally designed with a dessicant functionality having a finite water capacity. The maximum acceptable temperature of the reformate gas determines the size of the required dessicant means. Generally, the dessicant means is incorporated into the PSA vessels, and creates void volume that decreases hydrogen recovery. Thus, it is desirable to minimize the maximum reformate temperature in order to obtain the best possible hydrogen recovery efficiency in the PSA apparatus.

The capacity and selectivity of the adsorbents for removing typical reformate impurities, such as carbon oxides, unreacted hydrocarbons, nitrogen, and other gases, is also strongly dependent upon temperature. Low temperatures greatly improve selectivity and capacity of the adsorbents, although extremely low temperatures may adversely effect the kinetic parameters of the adsorbents. Thus, careful control of the reformate temperature is required for proper control of the PSA apparatus.

If the reformate temperature drops below the freezing point of water, then the piping of the hydrogen plant may become blocked by ice. Such blockages could cause a safety hazard, and certainly would lead to a need to shut the hydrogen plant down for sufficient time to remove the ice blockage. Thus, the reformate should not be cooled below the freezing point of water.

Hydrogen plants of the related art include a condenser system cooled by cooling water or cooling fluid. These heat exchangers are then connected to a chiller system, such as a water cooling tower or a mechanical refrigeration apparatus. Such systems suffer from high capital and operational costs. Mechanical refrigeration cycles require substantial amounts of energy to operate, and cooling towers or other evaporative cooling systems require careful maintenance to prevent scale formation, bio-fouling, and corrosion. Such cooling systems also require a large quantity of makeup water, which presents a significant cost and disposal burden. During freezing weather, cooling towers and evaporative coolers require careful attention to prevent the same ice formation issues that confront the reformate condenser and pipework.

Alternatively, related art hydrogen plants use air cooling with ambient air to cool the reformate condenser. Air cooling is limited in areas with incidences of high ambient temperatures by poor temperature control. This limits the applicability of air-cooled systems to areas with temperate climate, a low hydrogen purity requirement, or to PSA adsorbents that tolerate high operating temperatures.

The limitations of the related art hydrogen plants cooling systems require full-time operator supervision or extensive automation and control to ensure successful operation. These steps incur costs that have prevented reformer-based hydrogen plants from being economically viable at very small scales, despite their predominance at larger capacities where the cost and complexity is acceptable.

### SUMMARY OF THE INVENTION

In an effort to improve the efficiency and operability of hydrogen plants, the inventors have formulated various improvements as described below. For example, the present invention provides an improved hydrogen plant and method of producing purified hydrogen that can be operated in conditions of high ambient temperatures without the high penalty in energy consumption and operational complexity incurred by other methods in the art.

The present invention advantageously provides a hydrogen plant including a fuel reforming plant configured to receive and process hydrocarbon feedstock and configured to discharge wet reformate including a hydrogen-containing gas stream, and a condenser configured to cool the wet reformate. The hydrogen plant also includes at least one water separator configured to receive the cooled wet reformate, remove water from the wet reformate, and discharge dry reformate. The hydrogen plant further includes a hydrogen purifier configured to receive the dry reformate, process the dry reformate, and discharge pure or substantially pure hydrogen. The present invention includes a supplemental cooling system to cool the wet reformate in addition to the condenser.

In one advantageous embodiment of the present invention, the supplemental cooling system is a subterranean cooling system including a first heat exchange portion configured to absorb heat from the wet reformate using a supplemental cooling fluid and a second subterranean heat exchange portion configured to release heat from the supplemental cooling fluid to a subterranean environment.

In another advantageous embodiment of the present invention, the supplemental cooling system includes an inlet connected to a purified water source and an outlet connected to a purified water inlet of the fuel reforming plant. In this embodiment, the purified water is supplied to the inlet of the supplemental cooling system by a water supply that utilizes cool subterranean environmental as a heat sink so that the cooled water can be used as a cooling fluid in the supplemental cooling system.

In a still further advantageous embodiment of the present invention, the hydrogen plant further includes a water purifier having an inlet configured to receive raw water, a first outlet configured to discharge purified water, and a second outlet configured to discharge waste water. The first outlet is connected to a purified water inlet of the fuel reforming plant. The supplemental cooling system includes an inlet connected to the second outlet of the water purifier and an outlet. The water purifier can be, for example, a reverse osmosis purifier. The inlet of the water purifier is preferably configured to connect to a water supply that has a cool subterranean environment as a heat sink.

Furthermore, the present invention advantageously provides a method of producing purified hydrogen including processing hydrocarbon feedstock to produce a wet reformate including a hydrogen-containing gas stream, cooling the wet reformate using a condenser, and cooling the wet reformate using a supplemental cooling system. The method also includes removing water from the wet reformate to produce a dry reformate, and processing the dry reformate to produce pure or substantially pure hydrogen.

In one advantageous embodiment of the present invention, the supplemental cooling system does not require energy input beyond that required to overcome fluid friction in order to cool the wet reformate.

In another advantageous embodiment of the present invention, the processing of hydrocarbon feedstock is performed using a fuel reforming plant that discharges wet reformate at a temperature above 100° C. In another preferred embodiment, the dry reformate is processed using a pressure swing adsorption system, and a temperature at which the dry reformate enters the pressure swing adsorption system is controlled using the condenser and the supplemental cooling system. Preferably, the temperature at which the dry reformate enters the pressure swing adsorption system is below 45° C. More preferably, the temperature at which the dry reformate enters the pressure swing adsorption system is below 25° C. and above 0° C.

In a further advantageous embodiment of the present invention, the supplemental cooling system is a subterranean cooling system including a first heat exchange portion configured to absorb heat from the wet reformate using a supplemental cooling fluid and a second subterranean heat exchange portion configured to release heat from the supplemental cooling fluid to a subterranean environment.

In a still further advantageous embodiment of the present invention, the processing of hydrocarbon feedstock is performed using a fuel reforming plant, and the supplemental cooling system includes an inlet connected to a purified water source and an outlet connected to a purified water inlet of the fuel reforming plant. In this embodiment, the purified water is supplied to the inlet of the supplemental cooling system by a water supply that utilizes cool subterranean environmental as a heat sink so that the cooled water can be used as a cooling fluid in the supplemental cooling system.

In an additional advantageous embodiment of the present invention, the method further comprises purifying raw water to discharge purified water for use in the processing of the hydrocarbon feedstock, and to discharge waste water for use as cooling fluid in the supplemental cooling system. The raw water is preferably from a water supply that is at or near the local subterranean temperature.

Additionally, the present invention advantageously provides a method for minimizing a volume of dessicant used in a pressure swing adsorption apparatus. The method includes controlling a temperature and water content of reformate including a hydrogen-containing gas stream entering the pressure swing adsorption apparatus. The temperature and water content of the reformate is controlled using a condenser to cool the reformate, a supplemental cooling system to further cool the reformate, and a water separator to remove water from the cooled reformate.

Additionally, the present invention provides an improved method for generating hydrogen wherein both a condenser and a supplementary cooling system where the optimum steam to carbon ratio is elevated above the optimum value employed when a condenser alone is employed.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a schematic view of a first embodiment of a hydrogen plant of the present invention;

FIG. 2 is a schematic view of a second embodiment of a hydrogen plant of the present invention;

FIG. 3 is a schematic view of a third embodiment of a hydrogen plant of the present invention;

FIG. 4 is a schematic view of a fourth embodiment of a hydrogen plant of the present invention; and

FIG. 5 is a schematic view of a related art hydrogen plant.

### DETAILED DESCRIPTION OF THE INVENTION

The system of the present invention relates to a system and method for cooling reformate gas in a hydrogen plant. For example, the invention relates to a reformate gas cooling system and method for a pressure swing adsorption (PSA) type hydrogen plant that requires less energy, less water, less maintenance, and operates at ambient air temperatures above the pressure swing adsorption design temperature and below the freezing point of the condensed water.

Embodiments of the present invention will be described hereinafter with reference to the accompanying drawings. In the following description, the constituent elements having substantially the same function and arrangement are denoted by the same reference numerals, and repetitive descriptions will be made only when necessary.

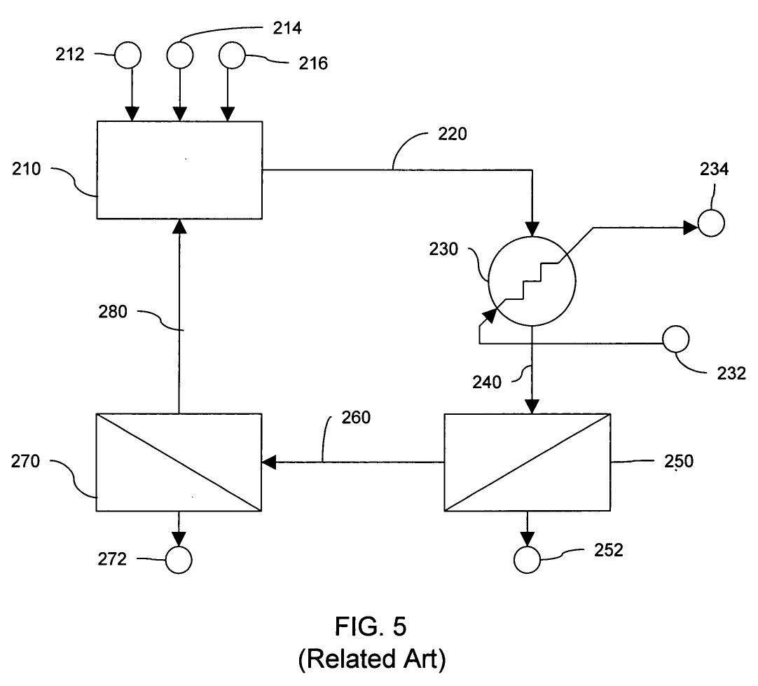

FIG. 5 depicts a related art hydrogen plant. The plant depicted in FIG. 5 includes a fuel reforming plant 210 having a feedstock fuel inlet 212, an air inlet 214, and a purified water inlet 216. Various types of fuels reformers can be used, such as a steam reformer, autothermal reformer, partial oxidation reformer, pyrolytic reformer, or any other suitable reformer. The fuel reformer 210 produces a wet reformate product at a temperature above 100° Celsius that contains some combination of hydrogen, unreacted hydrocarbon, carbon oxides, nitrogen, water vapor and various other minor constituents. Wet reformate travels along conduit 220 and is introduced into a condenser 230 to be cooled by heat exchange with a heat transfer fluid flowing from an inlet 232 to an outlet 234. The cooling fluid typically includes chilled water, ambient air, chilled air, vapor refrigeration cycle working fluid, or any other suitable fluid. Most systems typically utilize cooling water chilled to a very precisely controlled temperature at the facility via a separate process.

Cooled reformate leaves the condenser via conduit 240 at a reduced temperature below the temperature of reformate at the condenser inlet, and includes both a condensed liquid phase and vapor phase. Cooled reformate leaving the condenser outlet enters a water separator 250 where the liquid phase reformate is separated and rejected from the system via outlet 252 as condensed water, which may be recycled and input as purified water into the fuel reforming plant 210. Dry reformate exits the water separator via conduit 260.

Dry reformate enters a PSA hydrogen purifier, which separates the dry reformate into a pure or substantially pure hydrogen stream at outlet 272 and a reject a gas stream that contains some hydrogen and a majority of other reformate constituents. The reject gas can be transferred via conduit 280 and used as fuel gas in the fuel reforming plant 210.

The hydrogen plant depicted in FIG. 5 suffers from the types of problems discussed in the background section above.

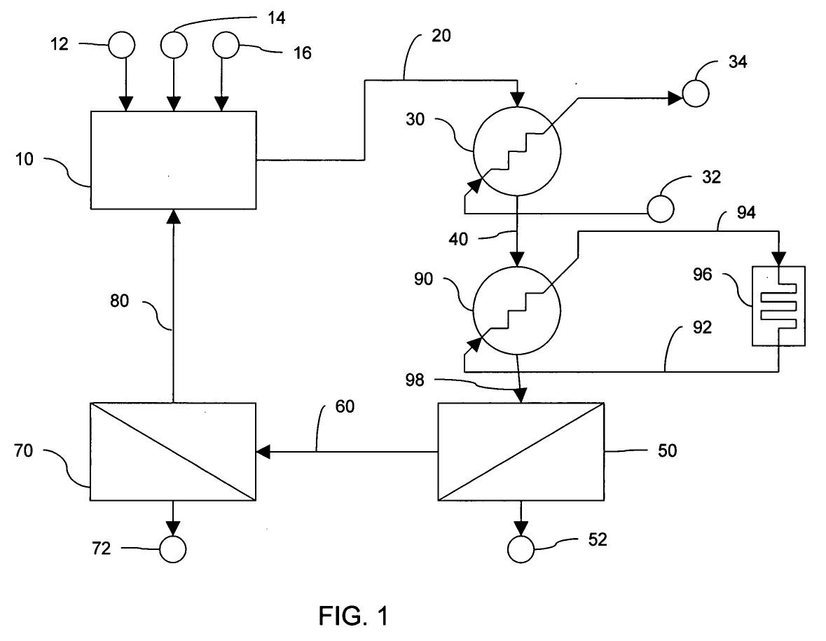

FIG. 1 depicts a first preferred embodiment of the present invention that includes a fuel reforming plant 10 having a feedstock fuel inlet 12, an air inlet 14, and a purified water inlet 16. Various types of fuels reformers can be used, such as a steam reformer, autothermal reformer, partial oxidation reformer, pyrolytic reformer, or any other suitable reformer. A particularly preferred reformer is disclosed in U.S. Pat. Nos. 6,623,719 and 6,497,856 to Lomax, et al., and another particularly preferred reformer is disclosed in related U.S. application Ser. No. 10/791,746, all of which are incorporated herein in their entirety. The fuel reformer 10 produces a wet reformate product at a temperature above 100° Celsius that contains some combination of hydrogen, unreacted hydrocarbon, carbon oxides, nitrogen, water vapor and various other minor constituents. Wet reformate travels along conduit 20 and is introduced into a condenser 30 to be cooled by heat exchange with a heat transfer fluid flowing from an inlet 32 to an outlet 34. The cooling fluid can include chilled water, ambient air, chilled air, vapor refrigeration cycle working fluid, or any other suitable fluid. The cooled reformate leaves the condenser 30 via conduit 40 at a reduced temperature below the temperature of reformate at the condenser inlet.

The first preferred embodiment of the invention includes an additional or supplemental cooling system having a heat exchanger 90, a wet reformate input via conduit 40, a cooling fluid inlet conduit 92, and a cooling fluid outlet conduit 94. The supplemental cooling system is run in conjunction with the condenser 30. Note that both the condenser 30 and the heat exchanger 90 preferably cause at least some finite amount of condensation in the reformate. As the cooling fluid in the supplemental cooling system circulates from the cooling fluid outlet conduit 94 back to the cooling fluid inlet conduit 92, it travels through an underground or subterranean heat exchanger 96. The underground/subterranean supplemental cooling system uses less energy and is more efficient than known standard condenser cooling systems because the temperature of the soil is below the ambient temperature in hot climates, and can advantageously be below the temperature attainable via evaporative cooling in a cooling tower (i.e. the wet bulb temperature). When used in conjunction with a condenser, the supplemental cooling system reduces the capacity requirements of the condenser and provides efficient cooling of the wet reformate.

The cooled reformate leaves the supplemental cooling system 90 via conduit 98 at a reduced temperature below the temperature of reformate at the supplemental cooling system inlet, and includes both a condensed liquid phase and vapor phase. The cooled reformate leaving the supplemental cooling system outlet enters a water separator 50 where the liquid phase reformate is separated and rejected from the system via outlet 52 as condensed water, which may be recycled and input as purified water into the fuel reforming plant 10. Dry reformate exits the water separator via conduit 60. The phrase “dry reformate”is dry in the sense that the reformate is generally free from liquid water droplets, and is dry relative to reformate leaving the fuel reforming plant. However, it is noted that “dry reformate” is generally saturated with water at the local temperature.

The dry reformate enters a PSA hydrogen purifier 70, which separates the dry reformate into a pure or substantially pure hydrogen stream at outlet 72 and a reject gas stream that contains some hydrogen and a majority of other reformate constituents. The reject gas can be transferred via conduit 80 and used as fuel gas in the fuel reforming plant 10.

Preferably, the temperature of dry reformate input to a PSA hydrogen purifier is below 45° C., more preferably below 35° C., and most preferably above 0° C. and below 25° C. At 45° C., reformate may contain 0.095 bar steam pressure. At 35° C., reformate may contain steam pressure of only 0.056 bar, over 40% less water vapor per unit volume. At 25° C., the steam pressure can be only 0.0317 bar. At 15° C., steam pressure drops to 0.017 bar. Thus, by cooling dry reformate between within the preferred temperature range, dramatic reductions in water vapor loading can be achieved which significantly reduces the required performance of the desiccant system in the PSA hydrogen purifier 70 for improved hydrogen recovery.

An alternative configuration of the present invention can include a combined heat exchanger that integrates both condenser 30 and supplemental cooling system 90 into a single heat exchange unit that extracts heat from the reformate. In such a configuration, the condenser 30 and the supplemental cooling system 90 will have separate cooling fluid circuits that discharge the heat in any preferred manner. For example, the condenser 30 can discharge heat from the cooling fluid circulating therein by using a cooling tower, while the supplemental cooling system 90 discharges heat from the cooling fluid circulating therein by using a subterranean heat exchanger. The combined heat exchanger can be, for example, a two-circuit brazed or welded plate heat exchanger, or other similar configuration.

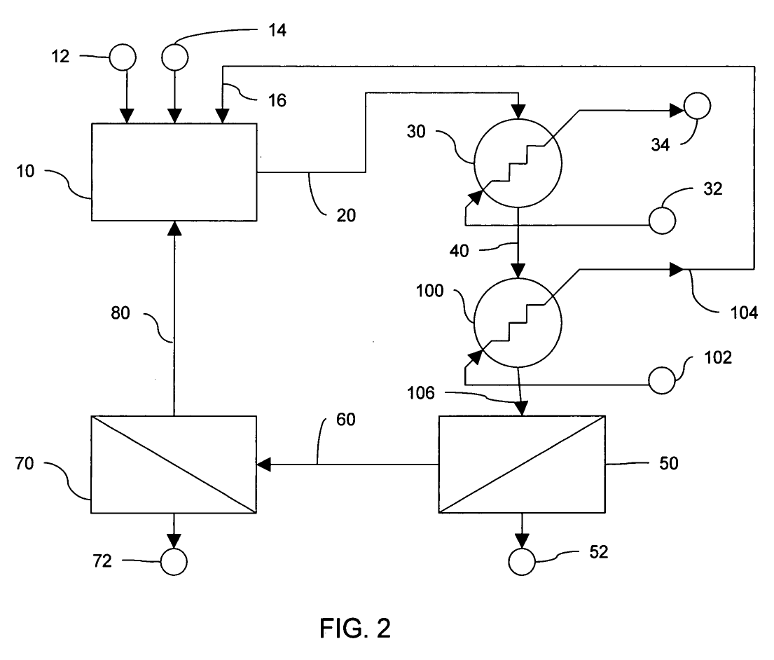

A second embodiment of the invention is shown in FIG. 2. The hydrogen plant depicted in FIG. 2 utilizes the same general system layout as the previous embodiment of FIG. 1. However, in the second preferred embodiment of FIG. 2, cool purified water is used as the cooling fluid which is input into the supplemental cooling system 100 at inlet 102. The output of cooling fluid in outlet conduit 104 is then input to the fuel reforming plant 10 at the purified water inlet 16. This second preferred embodiment takes advantage of the fact that purified water is supplied from a water supply that utilizes a cool subterranean environment as a heat sink either at its source or during transportation of the water, such as a municipal water supply, industrial water supply, well water supply, fresh water sources, or the like, and thus is generally cooler in temperature than ambient air during periods of hot weather. Utilizing this purified water for supplemental cooling of wet reformate enhances the PSA recovery of the invention above that of other systems. In addition, the cooling fluid input into inlet 102 can be run through an underground or subterranean heat exchanger or length of piping prior to be provided to the supplemental cooling system 100 if the cooling fluid can be further cooled in such a heat exchanger.

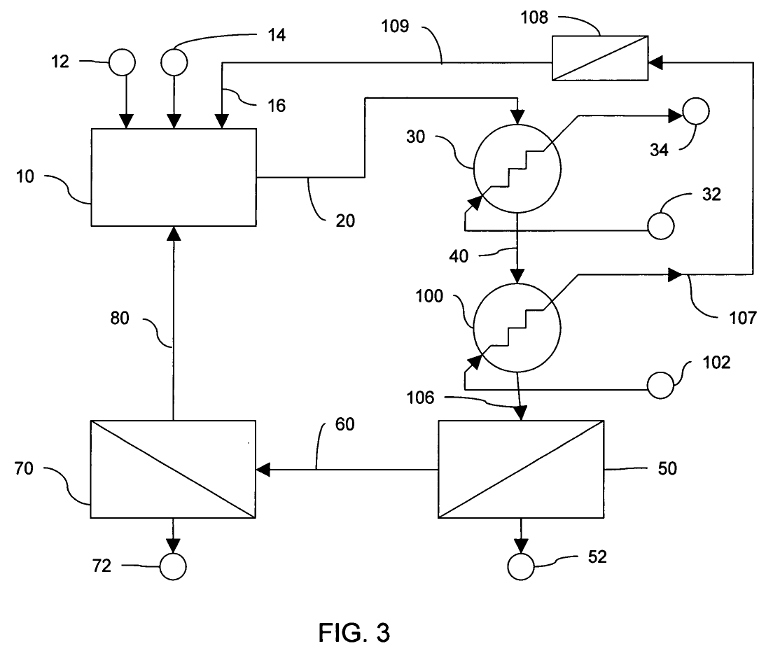

A third embodiment of the invention is shown in FIG. 3. The hydrogen plant depicted in FIG. 3 utilizes the same general system layout as the previous embodiments of FIGS. 1 and 2. However, in the third preferred embodiment of FIG. 3, cool raw water is used as the cooling fluid which is input into the supplemental cooling system 100 at inlet 102. The output of cooling fluid in outlet conduit 107 is then passed through a separate purifier 108, such as a reverse osmosis purifier, before being input into the purified water input 16 of the fuel reforming plant 10 via conduit 109. This embodiment takes advantage of the fact that raw water from a water supply that utilizes a cool subterranean environment as a heat sink, such as a municipal water supply, industrial water supply, well water supply, fresh water supply, or the like, is generally cooler in temperature than ambient air during periods of hot weather. Utilizing this water for supplemental cooling of wet reformate enhances the PSA recovery of the invention above that of other systems.

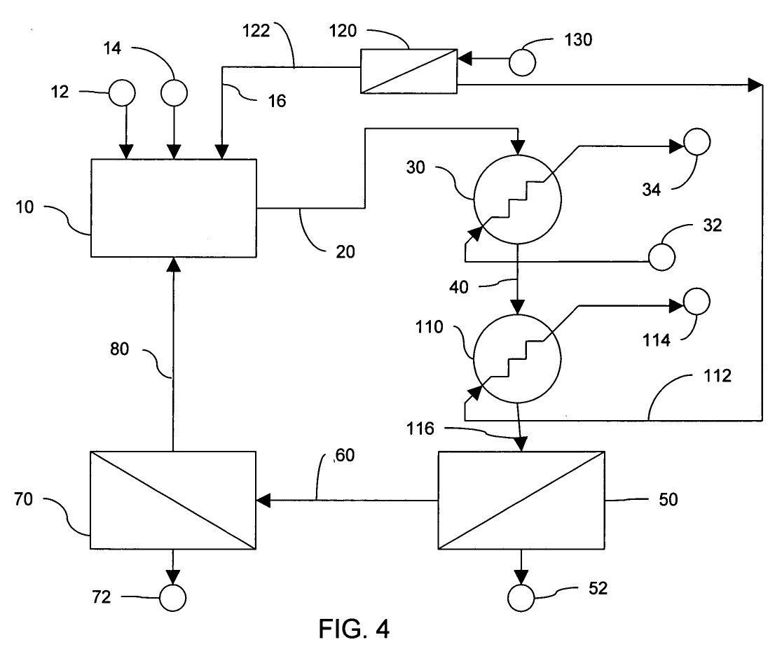

A fourth preferred embodiment of the invention is shown in FIG. 4. The hydrogen plant depicted in FIG. 4 utilizes the same general system layout as the previous embodiments of FIGS. 1-3. However, in the fourth preferred embodiment, cool raw water provided to an inlet 130 is passed through a separate purifier 120, such as a reverse osmosis purifier, before being input into the purified water input 16 of fuel reforming plant 10 via conduit 122 and the rejected impure water is supplied to the cooling water inlet 112 of a heat exchanger of a supplemental cooling system 110, which is run in conjunction with a standard condenser system. This embodiment of the invention takes advantage of the fact that raw water from a water supply that utilizes a cool subterranean environment as a heat sink, such as a municipal water supply, industrial water supply, well water supply, fresh water supply, or the like, is also generally colder in temperature than ambient air.

The heat exchanger of the present invention may be advantageously used to cool reformate in any hydrogen plant where local soil temperature is lower that the ambient air temperature. In the second and third exemplary embodiments, the use of the supply water, or process feedwater, can cause an undesirable reduction in thermal efficiency of the fuel reforming plant 10. This is because the purified process feedwater traveling through conduits 104, 107, or 122 is heated above its lowest possible temperature. If it is used as a heat exchange media for cooling a process stream, the efficiency of that heat exchange will be reduced. If, however, the impure waste water is used in the fourth embodiment, then the efficiency reduction does not occur.

An exemplary case is in the steam reforming process of U.S. Pat. Nos. 6,623,719 and 6,497,856 and U.S. application Ser. No. 10/791,746 In these processes, hot combustion product, or fluegas, is cooled by generating steam. The fluegas in these processes generally has a higher thermal mass flux than the process feedwater, in other words, it contains more energy per degree of temperature change. Thus, if the purified feedwater temperature increases, then there is a corresponding increase in the fluegas discharge temperature. Because the fluegas contains far more energy than the process feedwater for the same temperature increase, the net heat recovery of the reforming system is decreased.

Generally, within the preferred ratios of steam molar flow to carbon molar flow in the process of U.S. Pat. No. 6,623,719, thermal efficiency is optimized at lower ratios of steam to carbon. This optimum ratio depends upon the fuel, operating pressure, and operating temperatures chosen within the preferred ranges. However, if the supplemental cooling system of the present invention is employed, it is surprisingly found that the optimum ratio of steam to carbon is increased between 0.25:1 and 1:1. This is due to the lower preheated purified water temperature entering the reforming process at higher water flowrates. Thus, a reformer system provided with the supplemental cooling system of the present invention may be advantageously operated such that during periods of high ambient air temperature, where the purified process water temperature is substantially increased at the otherwise optimum steam to carbon ratios, the steam to carbon ratio may advantageously be increased to reduce the temperature of the water fed to the reformer.

It should be noted that the exemplary embodiments depicted and described herein set forth the preferred embodiments of the present invention, and are not meant to limit the scope of the claims hereto in any way.

Numerous modifications and variations of the present invention are possible in light of the above teachings. It is therefore to be understood that, within the scope of the appended claims, the invention may be practiced otherwise than as specifically described herein.

1. A hydrogen plant comprising:
a fuel reforming plant configured to receive and process hydrocarbon feedstock and configured to discharge wet reformate including a hydrogen-containing gas stream;
a condenser configured to cool the wet reformate;
a supplemental cooling system to cool the wet reformate;
a water separator configured to receive the cooled wet reformate, remove water from the wet reformate, and discharge dry reformate; and
a hydrogen purifier configured to receive the dry reformate, process the dry reformate, and discharge pure or substantially pure hydrogen.

2. The hydrogen plant according to claim 1, wherein said supplemental cooling system is a subterranean cooling system including a first heat exchange portion configured to absorb heat from the wet reformate using a supplemental cooling fluid and a second subterranean heat exchange portion configured to release heat from the supplemental cooling fluid to a subterranean environment.

3. The hydrogen plant according to claim 2, wherein said condenser includes a condenser circuit for circulating a cooling fluid, wherein said supplemental cooling system includes a supplemental circuit for circulating the supplemental cooling fluid, and wherein said condenser circuit and said supplemental circuit are separate.

4. The hydrogen plant according to claim 3, wherein said condenser and said first heat exchange portion of said supplemental cooling system utilize an integral heat exchanger to cool the wet reformate.

5. The hydrogen plant according to claim 3, wherein said supplemental cooling system includes an inlet connected to a purified water source and an outlet connected to a purified water inlet of said fuel reforming plant.

6. The hydrogen plant according to claim 1, wherein said supplemental cooling system includes an inlet connected to a purified water source and an outlet connected to a purified water inlet of said fuel reforming plant.

7. The hydrogen plant according to claim 6, wherein said inlet of said supplemental cooling system is configured to connect to a water supply that utilizes a cool subterranean environment as a heat sink in order to utilize water from the water supply as cooling fluid.

8. The hydrogen plant according to claim 1, further comprising a water purifier having an inlet configured to receive raw water, a first outlet configured to discharge purified water, and a second outlet configured to discharge waste water, said first outlet being connected to a purified water inlet of said fuel reforming plant, wherein said supplemental cooling system includes an inlet connected to said second outlet of said water purifier and an outlet.

9. The hydrogen plant according to claim 8, wherein said water purifier comprises a reverse osmosis purifier.

10. The hydrogen plant according to claim 8, wherein said inlet of said water purifier is configured to connect to a water supply that utilizes a cool subterranean environment as a heat sink.

11. The hydrogen plant according to claim 1, further comprising a water purifier having an inlet configured to receive raw water and an outlet configured to discharge purified water, said outlet being connected to a purified water inlet of said fuel reforming plant, wherein said supplemental cooling system includes an inlet configured to receive the raw water from a water supply and an outlet connected to said inlet of said water purifier.

12. The hydrogen plant according to claim 1, wherein the fuel reforming plant is at least one of a steam reformer, an autothermal reformer, a partial oxidation reformer, and a pyrolytic reformer.

13. The hydrogen plant according to claim 1, wherein said condenser configured to cool the wet reformate uses a chiller system configured to supply a cooling fluid to absorb heat from the wet reformate in a heat exchanger.

14. The hydrogen plant according to claim 13, wherein the chiller system is a water cooling tower.

15. The hydrogen plant according to claim 13, wherein the chiller system is a mechanical refrigeration apparatus.

16. The hydrogen plant according to claim 1, wherein said condenser is configured to cool the wet reformate using ambient air to absorb heat from the wet reformate in a heat exchanger.

17. The hydrogen plant according to claim 1, wherein said hydrogen purifier is configured to discharge a reject gas, and wherein said hydrogen plant further comprises a conduit configured to supply the reject gas to said fuel reforming plant.

18. The hydrogen plant according to claim 1, wherein said fuel reforming plant includes a fuel inlet configured to receive the hydrocarbon feedstock, an air inlet, and a purified water inlet.

19. The hydrogen plant according to claim 1, wherein said hydrogen purifier is a pressure swing adsorption system.

20. A hydrogen plant comprising:
means for receiving and processing hydrocarbon feedstock to produce a wet reformate including a hydrogen-containing gas stream;
first means for cooling the wet reformate;
second means for cooling the wet reformate;
means for receiving the cooled wet reformate and removing water from the wet reformate to produce a dry reformate; and
means for receiving and processing the dry reformate to produce pure or substantially pure hydrogen.

21. The hydrogen plant according to claim 20, wherein said second means for cooling is a subterranean cooling system including a first heat exchange portion configured to absorb heat from the wet reformate using a supplemental cooling fluid and a second subterranean heat exchange portion configured to release heat from the supplemental cooling fluid to a subterranean environment.

22. The hydrogen plant according to claim 21, wherein said first means for cooling includes a circuit for circulating a cooling fluid, wherein said second means for cooling includes a supplemental circuit for circulating a supplemental cooling fluid, and wherein said circuit and said supplemental circuit are separate.

23. The hydrogen plant according to claim 22, wherein said first means for cooling and said first heat exchange portion of said second means for cooling utilize an integral heat exchanger to cool the wet reformate.

24. The hydrogen plant according to claim 22, wherein said second means for cooling includes an inlet connected to a purified water source and an outlet connected to a purified water inlet of said means for receiving and processing hydrocarbon feedstock.

25. The hydrogen plant according to claim 20, wherein said second means for cooling includes an inlet connected to a purified water source and an outlet connected to a purified water inlet of said means for receiving and processing hydrocarbon feedstock.

26. The hydrogen plant according to claim 25, wherein said inlet of said second means for cooling is configured to connect to a water supply that utilizes a cool subterranean environment as a heat sink in order to utilize water from the water supply as cooling fluid.

27. The hydrogen plant according to claim 20, further comprising a means for purifying water having an inlet configured to receive raw water, a first outlet configured to discharge purified water, and a second outlet configured to discharge waste water, said first outlet being connected to a purified water inlet of said means for receiving and processing hydrocarbon feedstock, wherein said second means for cooling includes an inlet connected to said second outlet of said means for purifying water and an outlet.

28. The hydrogen plant according to claim 27, wherein said inlet of said means for purifying water is configured to connect to a water supply that utilizes a cool subterranean environment as a heat sink.

29. The hydrogen plant according to claim 20, further comprising a means for purifying water having an inlet configured to receive raw water and an outlet configured to discharge purified water, said first outlet being connected to a purified water inlet of said means for receiving and processing hydrocarbon feedstock, wherein said second means for cooling includes an inlet configured to receive the raw water from a water supply and an outlet connected to said inlet of said means for purifying water.

30. The hydrogen plant according to claim 20, wherein said first means for cooling is a chiller system configured to supply a cooling fluid to absorb heat from the wet reformate in a heat exchanger.

31. The hydrogen plant according to claim 30, wherein the chiller system is a water cooling tower.

32. The hydrogen plant according to claim 30, wherein the chiller system is a mechanical refrigeration apparatus.

33. The hydrogen plant according to claim 20, wherein said first means for cooling uses ambient air to absorb heat from the wet reformate in a heat exchanger.

34. The hydrogen plant according to claim 20, wherein said means for receiving and processing the dry reformate further produces a reject gas, and wherein said hydrogen plant further comprises a conduit configured to supply the reject gas to said means for receiving and processing hydrocarbon feedstock.

35. A method of producing purified hydrogen comprising:
processing hydrocarbon feedstock to produce a wet reformate including a hydrogen-containing gas stream;
cooling the wet reformate using a condenser;
cooling the wet reformate using a supplemental cooling system;
removing liquid water from the wet reformate to produce a dry reformate; and
processing the dry reformate to produce pure or substantially pure hydrogen.

36. The method according to claim 35, wherein the supplemental cooling system does not require energy input beyond that required to overcome fluid friction in order to cool the wet reformate.

37. The method according to claim 35, wherein the processing of hydrocarbon feedstock is performed using a fuel reforming plant that discharges wet reformate at a temperature above 100° C.

38. The method according to claim 35, wherein the dry reformate is processed using a pressure swing adsorption system, and wherein a temperature at which the dry reformate enters the pressure swing adsorption system is controlled using the condenser and the supplemental cooling system.

39. The method according to claim 38, wherein the temperature at which the dry reformate enters the pressure swing adsorption system is below 45° C.

40. The method according to claim 38, wherein the temperature at which the dry reformate enters the pressure swing adsorption system is below 35° C.

41. The method according to claim 38, wherein the temperature at which the dry reformate enters the pressure swing adsorption system is below 25° C. and above 0° C.

42. The method according to claim 35, wherein the supplemental cooling system is a subterranean cooling system including a first heat exchange portion configured to absorb heat from the wet reformate using a supplemental cooling fluid and a second subterranean heat exchange portion configured to release heat from the supplemental cooling fluid to a subterranean environment.

43. The method according to claim 42, wherein the condenser includes a circuit for circulating a cooling fluid, wherein the supplemental cooling system includes a supplemental circuit for circulating a supplemental cooling fluid, and wherein the circuit and the supplemental circuit are separate.

44. The method according to claim 43, wherein the processing of hydrocarbon feedstock is performed using a fuel reforming plant, and wherein the supplemental cooling system includes an inlet connected to a purified water source and an outlet connected to a purified water inlet of the fuel reforming plant.

45. The method according to claim 35, wherein the processing of hydrocarbon feedstock is performed using a fuel reforming plant, and wherein the supplemental cooling system includes an inlet connected to a purified water source and an outlet connected to a purified water inlet of the fuel reforming plant.

46. The method according to claim 45, wherein the inlet of the supplemental cooling system is configured to connect to a water supply that utilizes a cool subterranean environment as a heat sink in order to utilize water from the water supply as cooling fluid.

47. The method according to claim 35, further comprising purifying raw water to discharge purified water for use in the processing of the hydrocarbon feedstock, and to discharge waste water for use as cooling fluid in the supplemental cooling system.

48. The method according to claim 47, wherein the raw water is from a water supply that utilizes a cool subterranean environment as a heat sink.

49. The method according to claim 35, wherein the condenser is a chiller system configured to supply a cooling fluid to absorb heat from the wet reformate in a heat exchanger.

50. The method according to claim 49, wherein the chiller system is a water cooling tower.

51. The method according to claim 49, wherein the chiller system is a mechanical refrigeration apparatus.

52. The method according to claim 35, wherein the condenser uses ambient air to absorb heat from the wet reformate in a heat exchanger.

53. The method according to claim 35, wherein the processing of the dry reformate produces a reject gas, and wherein the reject gas is used in the processing of the hydrocarbon feedstock.

54. A method for minimizing a volume of dessicant used in a pressure swing adsorption apparatus, the method comprising:
controlling a temperature and water content of reformate including a hydrogen-containing gas stream entering the pressure swing adsorption apparatus,
wherein the temperature and water content of the reformate is controlled using a condenser to cool the reformate, a supplemental cooling system to further cool the reformate, and a water separator to remove water from the cooled reformate.

55. The method according to claim 54, wherein the supplemental cooling system does not require energy input beyond that required to overcome fluid friction in order to cool the reformate.

56. The method according to claim 54, wherein the temperature at which the reformate enters the pressure swing adsorption apparatus is below 45° C.

57. The method according to claim 54, wherein the temperature at which the reformate enters the pressure swing adsorption apparatus is below 35° C.

58. The method according to claim 54, wherein the temperature at which the reformate enters the pressure swing adsorption apparatus is below 25° C. and above 0° C.

59. The method according to claim 54, wherein the supplemental cooling system is a subterranean cooling system including a first heat exchange portion configured to absorb heat from the reformate using a supplemental cooling fluid and a second subterranean heat exchange portion configured to release heat from the supplemental cooling fluid to a subterranean environment.

60. The method according to claim 59, wherein the condenser includes a circuit for circulating a cooling fluid, wherein the supplemental cooling system includes a supplemental circuit for circulating a supplemental cooling fluid, and wherein the circuit and the supplemental circuit are separate.

61. The method according to claim 54, wherein the supplemental cooling system includes an inlet connected to a purified water source, and wherein the inlet of the supplemental cooling system is configured to connect to a water supply that utilizes a cool subterranean environment as a heat sink in order to utilize water from the water supply as cooling fluid.

62. The method according to claim 54, wherein the supplemental cooling system includes an inlet connected to a water purifier, and wherein the water purifier includes an inlet configured to receive raw water from a water supply that utilizes a cool subterranean environment as a heat sink.

63. The method according to claim 54, wherein the condenser is a chiller system configured to supply a cooling fluid to absorb heat from the reformate in a heat exchanger.

64. The method according to claim 63, wherein the chiller system is a water cooling tower.

65. The method according to claim 63, wherein the chiller system is a mechanical refrigeration apparatus.

66. The method according to claim 54, wherein the condenser uses ambient air to absorb heat from the reformate in a heat exchanger.
